(19) United States
(12) Patent Application Publication
(10) Pub. No.: US 2007/0070189 A1
(43) Pub. Date: Mar. 29, 2007

(54) Mobile terminal having camera

(75) Inventor: In Hwan Lee, Gyeonggi-do (KR)

Correspondence Address: Charles N.J. Ruggiero;Ohlandt, Greeley, Ruggiero & Perle, L.L.P., One Landmark Square, 10th Floor, Stamford, CT, 06901-2682, US

(73) Assignee: PANTECH CO., LTD.

(21) Appl. No.: 11/480,183

(22) Filed: Jun. 30, 2006

(30) Foreign Application Priority Data
Jun. 30, 2005 (KR) 10-2005-0058024

(51) Int. Cl. H04N 7/14

(52) U.S. Cl. 348/14.16

(57) ABSTRACT

A mobile terminal having a camera including: a main body capable of controlling information and communication, and outputting image information; a camera device rotatably combined with the main body and having a speaker hole outwardly projecting a sound from a speaker; and a sound guiding device combined with the main body inside and guiding the sound to the speaker hole by containing the speaker. In the mobile terminal having the camera, since a speaker hole faces toward a user, a sound projects towards the user regardless of a rotation of a camera device, so that user convenience is promoted and also a more aesthetically pleasing mobile terminal is provided in comparison to a conventional art.

### CROSS-REFERENCE TO RELATED APPLICATION

This application claims the benefit of Korean Patent Application No. 10-2005-0058024, filed on Jun. 30, 2005, in the Korean Intellectual Property Office, the disclosure of which is incorporated herein by reference.

### BACKGROUND OF THE INVENTION

1. Field of the Invention

The present invention relates to a mobile terminal having a camera, and more particularly, to a mobile terminal having a camera capable of allowing a sound from a speaker hole to be outputted toward a user regardless of which direction the camera is pointing, so that user convenience is promoted and also a more aesthetically pleasing mobile terminal is provided in comparison to a conventional art.

2. Description of Related Art

Normally, a mobile terminal is a type of a communication device capable of easily carried with by a user and transmitting and receiving speech among users. The terminal may include a Personal Digital Assistant (PDA), a cellular phone, a Personal Communication Service (PCS) phone, a hand-held PC, a CDMA-2000 (1× and 3×) phone, a wideband CDMA phone, a dual band/dual mode phone, a Global System for Mobile Communication (GSM) phone, a Mobile Broadband System (MBS) phone, a Digital Multimedia Broadcasting (DMB) phone, a notebook computer, and the like.

With incredible development of information technology, mobile terminal technology has been developed together, so various functions are added to a mobile terminal and become popularized, such as an Internet connection function, a TV receiving function, a function of taking a motion picture or a still picture of a subject, and transmitting/receiving the motion picture or the still picture function.

Since various functions for a mobile terminal are developed, mobile terminals having various types of a camera device capable of storing a motion picture or a photo file of a subject become popularized. Currently, in order to promote users' convenience while taking a picture, mobile terminals having a rotatable camera device configured with a capability of rotating a camera by a certain angle are released. FIG. 1 is a perspective view illustrating a conventional mobile terminal having a conventional camera device and FIG. 2 is a perspective view illustrating the camera device separated from the mobile terminal.

As illustrated in the FIG. 1 and FIG. 2, the conventional art includes a main body portion 20 for inputting/outputting information and controlling communication, a display 31 for outputting the information as an image, a slidable display portion 30 combined with the main body portion 20 and a camera device 10 rotatably combined with the display portion 30 and taking a picture of a subject.

The main body portion 20 includes a main body portion case 21 forming an exterior of the main body portion 20, a microphone 22 receiving speech information from a user, a circuit part (not shown), an input button 33 externally exposed on the main body portion case 21 for inputting information, and a battery (not shown) detachably combined on one side of the main body portion 20.

The display portion 30 includes a display portion case 32 enclosing a display 31, a circuit part (not shown) installed inside the display portion case 32, and a plurality of buttons 23 externally exposed on the display portion case 32 for inputting information.

The camera device 10 includes a rotation cylinder 13 which is rotatably combined with the display portion 30, a camera lens 11 which is in a type of a convex lens and combined with the rotation cylinder 13 to be rotatable, a speaker (not shown) combined with the rotation cylinder 13 to be rotatable and outputting speech information, a speaker hole 18 provided in the rotation cylinder 13 allowing the speaker to output speech information and provided in an opposite direction from where the convex camera faces, a flexible printed circuit board (FPCB) (not shown) connecting the camera lens 11 and the circuit part, and a cap 15 sealing a hole (not shown) provided to mount the camera lens 11 in the rotation cylinder 13.

A plurality of gooves 17 for a handle are provided on an external surface of the rotation cylinder 13, a speaker hole 18 is provided in an opposite direction from where the camera lens 11 faces to output speech information of the speaker outside.

The camera device 10 rotates the rotation cylinder 13 so that the camera lens 11 comes to face toward the subject, accordingly the speaker hole 18 may change the direction it is facing.

The above described mobile terminal having a conventional camera has a problem as described below.

The camera lens 11 is focused on the subject by rotating the rotation cylinder 13 and by watching the image displayed in the display 31. When the subject is properly positioned in the display 31, a still picture or a motion picture is able to be taken by pushing the input button 33 to take the picture. In this case, while rotating the rotation cylinder 13, the speaker hole 18 may face an undesirable direction. When an incoming call occurs while taking a picture, the user needs to rotate the rotation cylinder 13 to position the speaker hole 18 in the same direction with the microphone 22, then receiving the incoming call becomes possible. Namely, in regards to user convenience, usage confusion may occur when an incoming call occurs while taking a picture.

FIG. 3 is a perspective view illustrating another example of a mobile terminal having a camera using a convention technique.

As illustrated in FIG. 3, a camera device 10 is separately provided from a speaker hole 18. In the camera device 10, a speaker is not provided in a rotation cylinder 13, but provided inside a separate display portion 30. Accordingly, the speaker hole 18 is separately installed from the camera device 10.

The above described mobile terminal using the conventional technique has a problem described below.

The speaker hole 18 always faces in a same direction regardless of a rotation direction of the camera device 10, consequently when an incoming call occurs while taking a picture, a user doesn't need to rotate the rotation cylinder 18 to position the speaker hole 18 in the same direction with a microphone (not shown), after then the user is able to receive the incoming call. But, it is not convenient to manufacture the mobile terminal because the camera device 10, the speaker and the speaker hole 18 need to be separately combined with each other and the camera device 10 and the mobile terminal is not aesthetically pleasing since the speaker hole 18 is not positioned in the center of a display portion 30.

Additionally, the user must suffer a burden of checking a position of the speaker hole or the camera device while taking a picture or receiving an incoming call.

### BRIEF SUMMARY

The present invention provides a mobile terminal having the camera capable of allowing a speaker hole to face towards a user, and allowing a sound to project towards the user regardless of a rotation of a camera device, so that users' convenience is promoted and also a more aesthetically pleasing mobile terminal is provided in comparison to a conventional art.

According to the present invention, there is provided a mobile terminal having a camera including: a main body controlling information and communication, and outputting information; a camera device rotatably combined with the main body and having a speaker hole outwardly projecting a sound from a speaker; and a sound guiding device combined with the main body inside and guiding the sound to the speaker hole by containing the speaker.

According to the present invention, there is provided a slider type mobile terminal having a camera including: a main body portion for inputting and outputting information and controlling communication; a slidable display portion combined with the main body portion to outputting image information; a camera device rotatably combined with the display portion and having a penetrating speaker hole outwardly projecting a sound of a speaker; and a sound guiding device combined with the main inside body and guiding the sound of the speaker to the speaker hole by containing the speaker inside the main body.

The camera device includes: a rotation cylinder rotatably combined in an upper portion of the main body; a camera combination portion combined inside the rotation cylinder and rotating with the rotation cylinder; and a camera unit coupled with the camera combination portion.

The rotation cylinder includes: a protruding hinge on one side of the rotation cylinder and combined in an insert hole provided in a hinge combination portion of the display portion; a sliding protrusion formed inside of the rotation cylinder in a cylindrical direction and rotatably combined in a guiding groove provided in the sound guiding device; a fixing protrusion combined with the camera combination portion and allowing the camera combination portion to rotate when the rotation cylinder rotates; and a camera hole provided in a symmetrical location to externally expose a camera lens.

The camera combination portion includes: a camera support fixing the camera unit to be coupled; and a fixing disk provided on one side of the camera support and combining with a fixing protrusion provided inside the rotation cylinder.

The speaker hole is formed as a plurality of speaker holes, and the plurality of speaker holes are provided along the rotation cylinder and have a 180 degree separation therebetween.

The plurality of speaker holes may be provided in the rotation cylinder and positioned in parallel to rotate with the camera unit and the camera device appears to be located in an upper center of the main body and is symmetrically configured from a rotation axis.

The sound guiding device includes: a cylinder body formed in a hollow type and open in a lateral face to allow a sound of the speaker to be externally projected; a speaker fixing structure provided inside the cylinder body and fixing the speaker; a sound guide formed inside the cylinder body and expansively provided from the speaker to the speaker hole to guide the sound from the speaker to the speaker hole; and a slidable guide groove provided on an outer surface of the cylinder body in a cylindrical direction and combined with a sliding protrusion provided inside a rotation cylinder in order to be slid.

The sound guiding device further comprises a light emitting diode (LED) installed in opposite output direction of the output sound of the speaker and emitting light according to a signal.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a perspective view illustrating a mobile terminal having a conventional camera device;

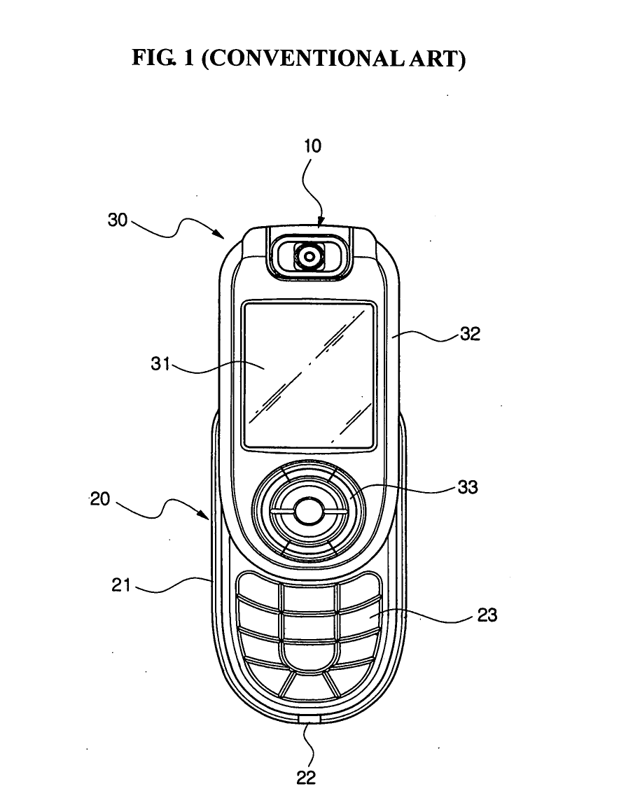

FIG. 2 is a perspective view illustrating the camera device from the conventional mobile terminal of FIG. 1;

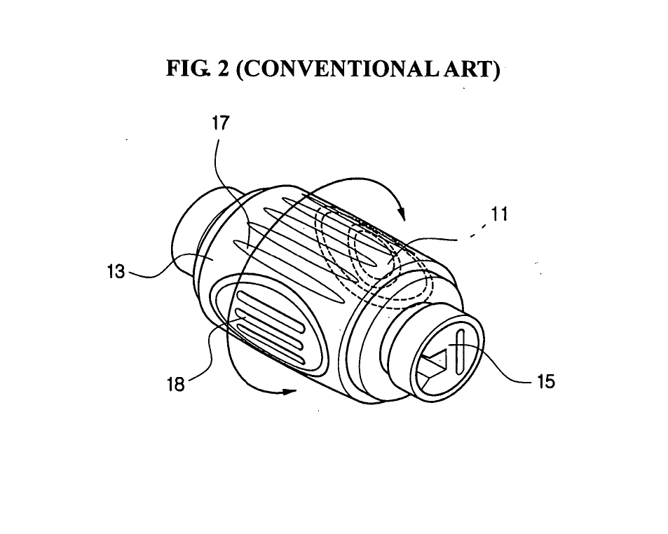

FIG. 3 is a perspective view illustrating another example of a mobile terminal having a camera device using a convention technique;

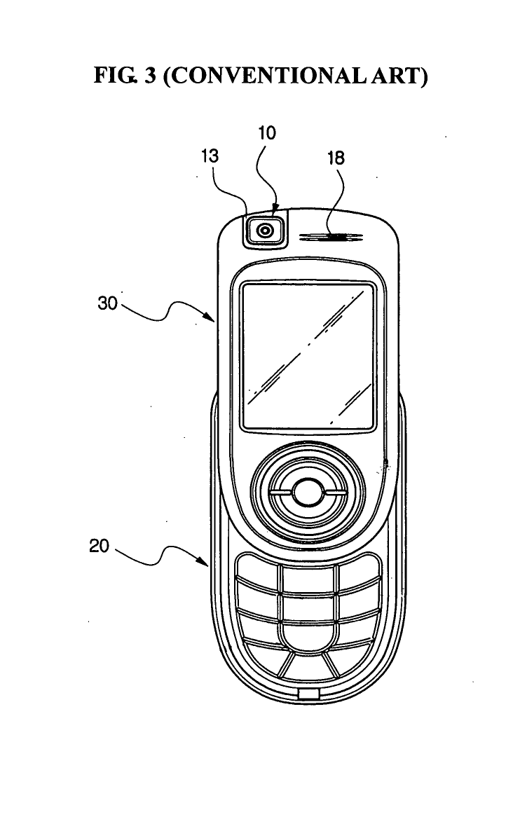

FIG. 4 is a front view illustrating a mobile terminal having a camera device according to a first embodiment of the present invention;

FIG. 5 is a cross-sectional view illustrated along a V-V line in FIG. 4;

FIG. 6 is an exploded perspective view illustrating a camera device according to a first embodiment of the present invention; and

FIG. 7 is a perspective view illustrating a mobile terminal having a camera device according to a second embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

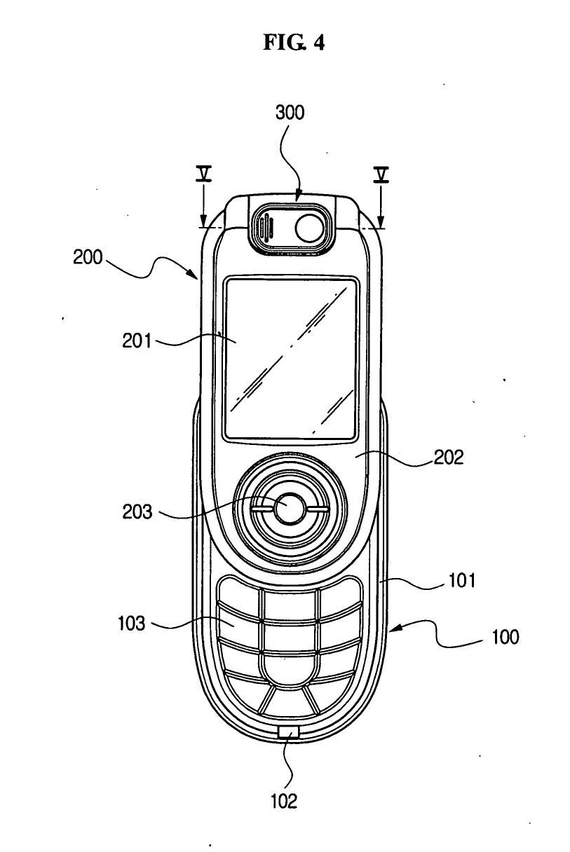

FIG. 4 is a front view illustrating a mobile terminal having a camera according to a first embodiment of the present invention.

As illustrated in FIG. 4, a slide type mobile terminal having the camera includes a main body 100, a display portion 200, a camera device 300, and a sound guiding device (not shown) combined inside the display portion 200.

The main body 100 includes a case 101 forming an exterior of the mobile terminal, a microphone 102 receiving speech information from a user, a circuit part (not shown) installed inside the case 101 processing information and controlling communication, a plurality of input buttons 103 externally exposed on the case 101 and transferring input information to the circuit part, a battery (not shown) detachably combined on one side of the main body portion 100 and the like.

The display portion 200 includes a display 201 outputting an image, a display portion case 202 enclosing the display 201, a circuit part (not shown) installed inside the display portion case 202, a plurality of buttons 203 externally exposed on the display portion case 202, such as a navigation key and the like.

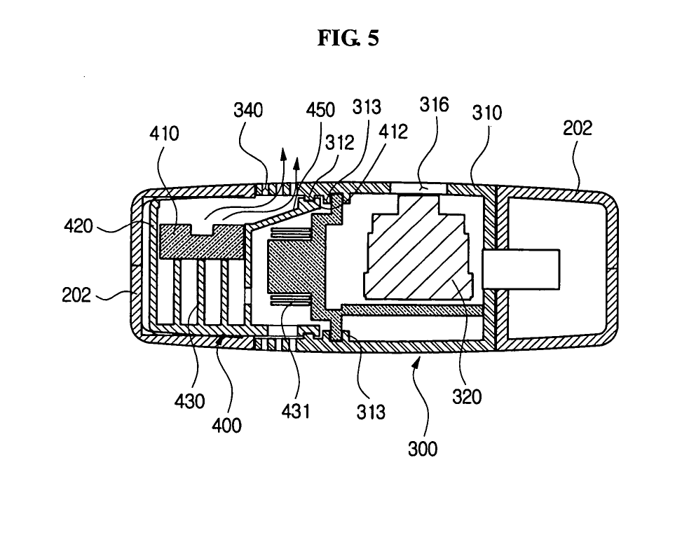

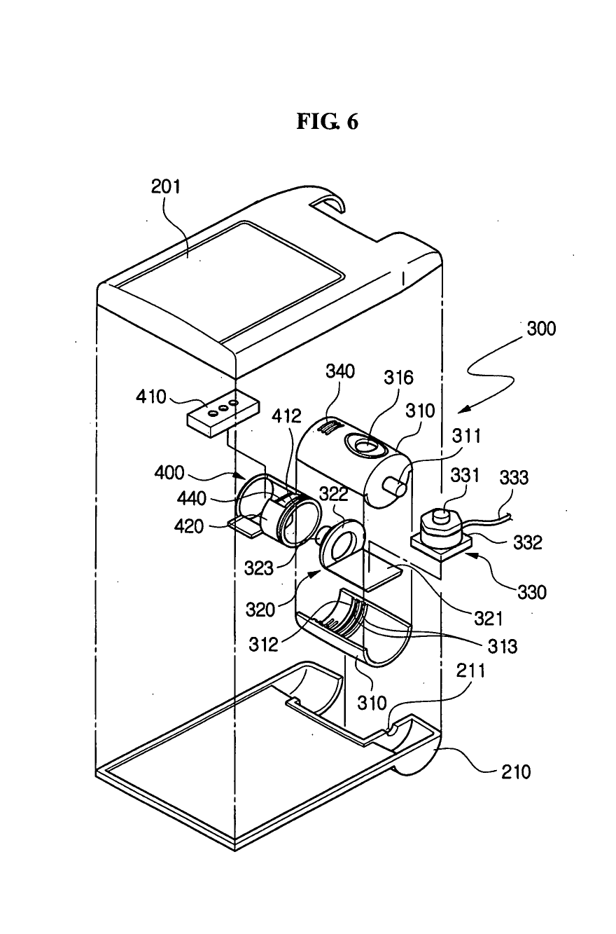

The camera device 300 is rotatably combined with the display portion 200 and the camera device 300. A sound guiding device will be illustrated in detail with reference to FIG. 5 and FIG. 6.

FIG. 5 is a cross-sectional view illustrated along a V-V line in FIG. 4 and FIG. 6 is an exploded perspective view illustrating a camera device according to a first embodiment of the present invention.

As illustrated in FIG. 5 and FIG. 6, a camera device 300 includes a rotation cylinder 310 rotatably combined in upper portion of a display portion, a camera combination portion 320 combined inside the rotation cylinder 310 and rotating with the rotation cylinder 310, a camera unit 330 rotatably coupled with the camera combination portion 320, a speaker hole 340 provided along the rotation cylinder 310 and outwardly projecting a sound of a speaker 410.

The rotation cylinder 310 includes a protruding hinge 311 on one side of the rotation cylinder 310 and combined in an insert hole 211 provided in a hinge combination portion 210 of a display portion, a sliding protrusion 312 formed inside of the rotation cylinder 310 in a cylindrical direction and rotatably combined in a guide groove 412, which will be described below, to be slidable, a fixing protrusion 313 combined with the camera combination portion 320 and allowing a camera support 321 to rotate when the rotation cylinder 310 rotates and a camera hole 316 provided in a symmetrical location to externally expose a camera lens 331.

The sliding protrusion 312 and the guiding groove 412 are adjacent to but not fixed to each other, to slides against each other fixing protrusion 313 is inwardly protruded on the rotation cylinder 310 in a cylindrical direction and two are formed in parallel in order to be fixed with a circumferential portion 322 of a fixing disk 323 of a camera combination portion 320, which will be described below. A distance between two protrusions of the fixing protrusion 313 is formed in a same width as the circumferential portion 322 of the fixing disk 323 to be combined.

The camera combination portion 320 includes a camera support 321 fixing the camera unit 330 to be coupled and a fixing disk 322 provided on one side of the camera support 321 and combining with fixing protrusion 313 provided inside the rotation cylinder 310.

The camera combination portion 320 rotates with the rotation cylinder 310 since the fixing disk 322 portion combines with the fixing protrusion 313.

The fixing disk 322 may be inserted to a combination groove 431 inside of the sound guiding device 400 since a protrusion 323 is provided in a center of the fixing disk 322.

The camera unit 330 includes a lens 331 which is in a type of a convex lens concentrating an image of a subject, a frame 332 enclosing the lens 331 and a camera signal cable 333 transferring an image signal to a circuit part installed in the main body 100 in FIG. 4.

The camera unit 330 is combined on the camera support 321, the camera support 321 is fixed to the rotation cylinder 310 by the fixing disk 322, and accordingly, the camera unit 330 rotates with the rotation cylinder 310. Consequently, when a user needs to take a picture, the rotation cylinder 310 is rotated and the camera lens 331 may face the subject according to various locations of the subject.

The camera signal cable 333 may be made of a flexible printed circuit board (FPCB).

The piercing speaker hole 340 is provided in one side of the rotation cylinder 310, and may be variously provided in its size and in its shape. Also, since one speaker hole is able to be provided, and a plurality of the speaker holes are able to be variously provided, so that two of the speaker holes 34 having a 180 degree separation from each other, or four of the speaker holes being disposed at 90 degree intervals are able to be provided along the rotation cylinder 310.

The camera device 300 appears to be located in an upper center of the display 200 portion and is symmetrically configured from a rotation axis.

The sound guiding device 400 includes a cylinder body 420 formed in a hollow type and an open lateral face to allow a sound of the speaker to be projected outwardly, a speaker fixing structure 430 provided inside the cylinder body 420 and fixing the speaker 410, a sound guide 440 formed inside the cylinder body 420 and expansively provided from the speaker 410 to the speaker hole 340 to guide a sound from the speaker 410 to the speaker hole 340, and a slidable guide groove 412 provided on an inner/outer surface of the cylinder body 420 in a cylindrical direction and combined with a sliding protrusion 312 inwardly provided on an inside of the rotation cylinder 310 in order to be slid.

The cylinder body 420 is fixed to the display portion 200 and the speaker 410 is installed inside. Also, the guiding groove 412 provided on an inner/outer surface of the cylinder body 420 is not fixed to the sliding protrusion 312, but slidably combined with the sliding protrusion 312, so when the rotation cylinder 310 rotates, the speaker 410 fixed to the cylinder body 420 may not rotate.

Namely, the camera device 300, when viewed externally, is symmetrically configured from the rotation axis of the rotation cylinder 310 so that the camera unit 330 and the speaker hole 340 appear to be positioned in parallel and rotate together. However, in an actual internal configuration, the speaker 410 is not provided inside the rotation cylinder 310, but fixed to the cylinder body 420 and thus, sound is directed by the sound guiding device 440 to change direction toward the speaker hole 340 and externally projected.

Below, operations and effectiveness of a mobile terminal having a camera according to the present invention will be described.

The camera lens 331 is focused on the subject by rotating the rotation cylinder 310, and by watching the image displayed in a display 201, and when the subject is properly positioned in the display 201, a still picture or a motion picture is able to be taken by pushing a button for taking a picture. In this case, the speaker hole 340 may face toward an unwanted direction while rotating the rotation cylinder 310 since the speaker hole 340 is provided in the rotation cylinder 310. When an incoming call occurs while taking a picture, a sound is outputted from the speaker 410 and reflected toward a center by the sound guide 440, and outputted through a most closest speaker hole 340. Namely, the sound appears to be emanating from the center, even when the camera unit 330 is facing a random direction, the sound is guided toward the user in a certain direction. Subsequently, when an incoming call occurs while taking a picture, the user does not need to rotate the rotation cylinder 310 to point the speaker hole 340 toward the user to receive the call. As described above, since the sound projects only toward the user, so that even when the camera device 300 rotates, the sound is clearly heard.

Also, considering user convenience, a usage confusion when an incoming call occurs while taking the picture may be eliminated.

Also, in appearance, the camera device 300 is symmetrically configured from an axis of a rotation cylinder 310 and the camera unit 330 is positioned in parallel with the speaker hole 340, so that a more aesthetically pleasing mobile terminal is provided in comparison to a conventional art.

Below, with respect to a description of a second embodiment of the present invention, the description regarding a main body, a display portion, and a camera device will be omitted since the description is the same as the description of the first embodiment of the present invention.

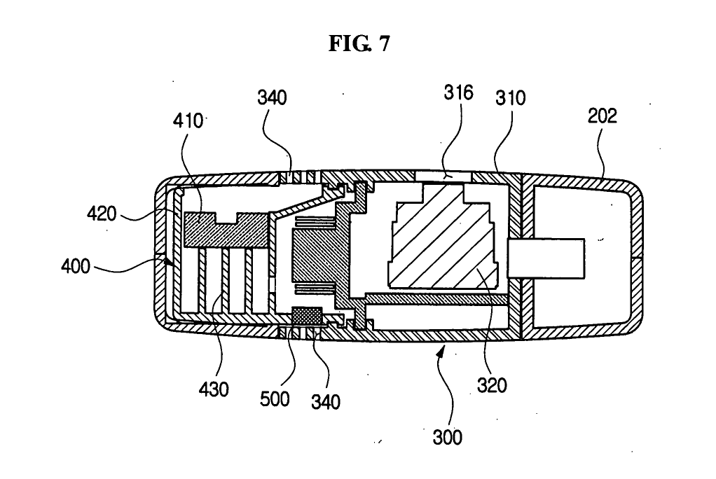

FIG. 7 is a perspective view illustrating a mobile terminal having a camera unit according to the second embodiment of the present invention.

As illustrated in FIG. 7, the sound guiding device 400 further includes an LED 500 provided in the cylinder body 420 in an opposite output direction of an output sound of the speaker 410, and emitting a light according to a signal.

The LED 500 may be a flash LED.

The piercing speaker hole 340 is provided on one side of the rotation cylinder 310 and functions as a type of a window to output the light of the LED as the rotation cylinder 310 rotates. As described above, since one speaker hole is able to be provided and also a plurality of the speaker holes are able to be variously provided so that two of the speaker holes 340 having a 180 degree separation from each other, or four of the speaker holes 340 being disposed at 90 degrees intervals are able be provided along the rotation cylinder 310.

According to the second embodiment of the present invention, when an incoming call occurs while taking a picture, a sound is outputted from the speaker 410, reflected toward a center by the sound guide 440, and outputted through a most closest speaker hole 340. Also, since the LED 500 emits a light in an opposite direction from where the speaker 410 faces, the speaker hole 340 may provide the user with auditory information and also visual information.

Since the sound is projected only toward the user due to the sound guide 440, even if the camera device 300 rotates, the sound may be clearly heard. Also, it is more convenient to determine whether an incoming call occurs or not since the LED 500 emits a light in an opposite direction from where the speaker 410 faces.

Also, similar to the first embodiment of the present invention, according to the second embodiment of the present invention, the camera device 300 is symmetrically configured from the rotation axis of the rotation cylinder 310 and the camera unit 330 and the speaker hole 340 are positioned in parallel, so that a more aesthetically pleasing mobile terminal is provided in comparison to a conventional art, and a usage confusion when an incoming call occurs while taking a picture may be eliminated.

Consequently, according to the present invention, even if the camera unit 330 is pointed at random, the sound may always project towards the user, so that the sound may be clearly heard and when an incoming call occurs while taking a picture, the user does not need to rotate the rotation cylinder 310 to point the speaker hole 340 toward the user to receive the call.

Also, considering user convenience, a usage confusion when an incoming call occurs while taking the picture may be eliminated.

Also, the camera device 300 is symmetrically configured from an axis of a rotation cylinder 310 and the camera unit 330 is positioned in parallel with the speaker hole 340, so that a more aesthetically pleasing mobile terminal is provided in comparison to a conventional art.

Also, the camera unit 330 is positioned in parallel with the speaker hole 340, so that the user needs not suffer a burden of checking a position of the speaker hole or the camera device while taking a picture or receiving an incoming call.

Also, according to the second embodiment of the present invention, the user is able to easily recognize whether an incoming call occurs because auditory information and also visual information are provided from the speaker hole by installing an LED in an opposite direction from where a speaker faces.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A mobile terminal having a camera, the mobile terminal comprising:
a main body controlling information and communication, and outputting information;
a camera device rotatably combined with the main body and having a speaker hole outwardly projecting a sound from a speaker; and
a sound guiding device combined with the main body inside and guiding the sound to the speaker hole by containing the speaker.

2. The mobile terminal of claim 1, the camera device comprising:
a rotation cylinder rotatably combined in an upper portion of the main body;
a camera combination portion combined inside the rotation cylinder and rotating with the rotation cylinder; and
a camera unit coupled with the camera combination portion.

3. The mobile terminal of claim 2, the camera combination portion comprising:
a camera support fixing the camera unit to be coupled; and
a fixing disk provided on one side of the camera support and combining with fixing protrusion provided inside the rotation cylinder.

4. The mobile terminal of claim 1, wherein a plurality of speaker holes are provided along the rotation cylinder.

5. The mobile terminal of claim 1, wherein the camera device appears to be located in an upper center of the main body and is symmetrically configured from a rotation axis.

6. The mobile terminal of claim 2, wherein the speaker hole is provided in the rotation cylinder and positioned in parallel to rotate with the camera unit.

7. The mobile terminal of claim 1, the sound guiding device comprising:
a cylinder body formed with a hollow center and open in a lateral face to allow a sound of the speaker to be externally projected;
a speaker fixing structure provided inside the cylinder body and fixing the speaker;
a sound guide formed inside the cylinder body and expansively provided from the speaker to the speaker hole to guide the sound from the speaker to the speaker hole; and
a slidable guide groove provided on an inner/outer surface of the cylinder body in a cylindrical direction and combined with a sliding protrusion provided inside a rotation cylinder in order to be slid.

8. The mobile terminal of claim 1, wherein the sound guiding device further comprises a light emitting diode (LED) installed in opposite output direction of the output sound of the speaker and emitting light according to a signal.

9. The mobile terminal of claim 8, wherein the LED is embodied as a flash LED.

10. The mobile terminal of claim 8, wherein a plurality of speaker holes are provided along the rotation cylinder.

11. A mobile terminal having a camera, the mobile terminal comprising:
a main body portion for inputting and outputting information and controlling communication;
a slidable display portion combined with the main body portion and outputting image information;
a camera device rotatably combined with the display portion and having a penetrating speaker hole outwardly projecting a sound from a speaker; and
a sound guiding device combined with the main body inside and guiding the sound of the speaker to the speaker hole by containing the speaker inside the main body.

12. The mobile terminal of claim 11, the camera device comprising:
a rotation cylinder rotatably combined in an upper portion of the main body;
a camera combination portion combined inside the rotation cylinder and rotating with the rotation cylinder; and
a camera unit coupled with the camera combination portion.

13. The mobile terminal of claim 12, the rotation cylinder comprising:
a protruding hinge on one side of the rotation cylinder and combined in an insert hole provided in a hinge combination portion of the display portion;
a sliding protrusion formed inside of the rotation cylinder in a cylindrical direction and rotatably combined in a guide groove provided in the sound guiding device;
a fixing protrusion combined with the camera combination portion and allowing the camera combination portion to rotate when the rotation cylinder rotates; and
a camera hole provided in a symmetrical location to externally expose a camera lens.

14. The mobile terminal of claim 12, the camera combination portion comprising:
a camera support fixing the camera unit to be coupled; and
a fixing disk provided on one side of the camera support and combining with a fixing protrusion provided inside the rotation cylinder.

15. The mobile terminal of claim 11, wherein a plurality of speaker holes are provided along the rotation cylinder.

16. The mobile terminal of claim 15, wherein the plurality of speaker holes are provided along the rotation cylinder and have a 180 degree separation therebetween.

17. The mobile terminal of claim 11, wherein the camera device appears to be located in an upper center of the main body and is symmetrically configured from a rotation axis.

18. The mobile terminal of claim 12, wherein the speaker hole is provided in the rotation cylinder and positioned in parallel to rotate with the camera unit.

19. The mobile terminal of claim 11, the sound guiding device comprising:
a cylinder body formed in a hollow type and open in a lateral face to allow a sound of the speaker outwardly;
a speaker fixing structure provided inside the cylinder body and fixing the speaker;
a sound guide formed inside the cylinder body and expansively provided from the speaker to the speaker hole to guide the sound from the speaker to the speaker hole; and
a slidable guide groove provided on an inner/outer surface of the cylinder body in a cylindrical direction and combined with a sliding protrusion provided inside a rotation cylinder in order to be slid.

20. The mobile terminal of claim 11 wherein the sound guiding device further comprises an LED provided in an opposite output direction of the output sound of the speaker and emitting light according to a signal.

21. The mobile terminal of claim 20, wherein the LED is embodied as a flash LED.

22. The mobile terminal of claim 20, wherein the plurality of speaker holes are provided along the rotation cylinder and have a 180 degree separation therebetween.
